(19) United States
(12) Patent Application Publication
(10) Pub. No.: US 2007/0000744 A1
(43) Pub. Date: Jan. 4, 2007

(54) Monitoring system for electrical vehicles drawing current from conductors

(76) Inventors: Martin Craig, South Wales (GB); Peter Joseph, Swansea (GB); Simon Willett, Swansea (GB)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 10/595,533

(22) PCT Filed: Oct. 28, 2004
(86) PCT No.: PCT/GB04/04569

§ 371 Date: Apr. 26, 2006

(30) Foreign Application Priority Data
Oct. 31, 2003 (GB) 0325508.0

(51) Int. Cl. B60L 9/00

(52) U.S. Cl. 191/2

(57) ABSTRACT

A current collector comprises one or more Fibre Bragg Grating sensors mounted on or in the current collector. Such collector can be used in a system in which:—i) detector means in the collector indicates a current collector condition and/or damage signal at a predetermined level likely to cause damage to the overhead conductor; ii) locating means operatively connected to said detector means generate a signal indicating the location of the pantograph on the overhead conductor at which the current collector damage signal was generated. Such a system can monitor not only impact forces on the collector, but also contact force and collector temperature.

This invention relates to a monitoring system for electrical vehicles drawing current from conductors, for example overhead conductors or powered rails, and to current collectors incorporating sensors particularly, but not exclusively, capable of use in such systems.

Electrified railway vehicles derive power from an overhead contact wire system (commonly known as an overhead contact line or OCL) or a powered rail. With the overhead system, typically a pantograph mechanism placed on the roof of the vehicle comprises a current collector that transfers current from the overhead wire to drive the vehicle. [An alternative arrangement is used for some trolley buses, which use a collector on a trolley pole. The present invention encompasses such arrangements and is intended to cover all systems in which a vehicle draws current from a conductor]. While this arrangement has been generally satisfactory, over the years the operational speed of railway vehicles has increased and the margins of acceptable current collection have been reduced. Moreover, cheaper and lighter overhead equipment on high voltage AC systems has been widely used. Dynamic impacts (which may damage the current collector on the overhead pantograph head) increase dramatically with the increase of speed and the use of lightweight overhead equipment. The following description therefore concentrates on high speed rail transport but the invention may find useful application on lower speed transport.

Any damage caused to the OCL has a negative effect on both track and train operators, with the producer of the damage being charged a penalty for preventing other company's scheduled operation of train or track.

With the increasing number of high speed trains in some European countries this problem is becoming more pronounced as any deviation from the correct contact force of the current collector produces excessive uplift of the OCL with risk of severe damage. At a minimum, incorrect contact force produces excessive wear of the current contacts (collector and OCL) and possible environmental noise due to arcing.

Existing high speed train pantographs apply an upward force, however there is no direct measurement used presently for on-line monitoring of the contact force.

Neither is there any type of temperature measurement for detecting thermal overload conditions which can occur, for example, when the train is standing still at a station and the current collector draws power from the OCL for auxiliary systems (e.g. air conditioning) without the cooling effect from wind flow.

Several attempts have been made to provide on-line real-time monitoring of the electrical infrastructure. One approach is to measure the wear of the OCL with a specially equipped train with high speed video cameras installed on the top. By fast image processing the moving image recorded as the train passes under OCL, the cross section of the wire is calculated and the resultant wear is derived from its deviation from the ideal circular section. This method is quite successful but is intended for an inspection train only, due to its complexity and cost.

Cracks can develop in the current collector when the current collector suffers a large impact. A crack in the current collector may trap or pull down the overhead line. If this happens then the pantograph must be freed from the line and the line replaced before the vehicle can continue. Any damage to the overhead wire must be dealt with as soon as possible to maintain the reliability of the train service and limit costs. It is therefore important to locate actual damage on the overhead wire. In some cases, by the time the train operator has realised that damage has occurred, he is considerably further down the train track and is unable to tell with any accuracy where the damage to the line occurred.

Pantographs of modern, high-speed, electrified trains may use current collectors made of a carbon material to minimise the wear of the overhead wire. However, carbon is susceptible to crack damage.

Damage detectors for current collectors have been described. For example, GB 1374972 and GB 2107662 describe systems to measure damage to a current collector that comprise placing a tube in a cavity in the current collector. The tube bursts when a crack in the current collector reaches the cavity. Such systems can be used to provide an “auto drop” feature. When the tube bursts, pressure drops in the system. The loss is detected, and an automatic auto-drop device lowers the pantograph removing contact with the OCL and preventing any possible damage.

With such pneumatic systems there is no means of re-lifting the pantograph following a pressure loss, the detection response is relatively slow and they do not provide a means of predicting the life of the collector or providing information on the condition of the OCL.

Many sensing arrangements comprising optical fibres are known, for example EP-A-0269307 describes embedding an optical fibre in a current collector. An optical signal (e.g., from a LED source) is transmitted through the optical fibre and is received by a detector at its opposite end. Any crack damage to the current collector that reaches the optical fibre affects the optical signal and is thus detected.

Systems have also been developed to detect wear of a current collector. For example, DE-U-8803377.5 and EP-A-0525595 describe systems in which a plurality of optical fibres are placed in the current collector at different distances from the wear surface. The wear level of the pantograph can be deduced when, for example, damage occurs to the optical fibre closest to the wear surface of the current collector but not to an optical fibre further away.

British Rail Research, of Derby, England, have worked on the monitoring, separately, of both pantograph damage and overhead conductor condition. On British Rail pantographs a pneumatic automatic dropping device is used which detects a damaged carbon strip and automatically drops the damaged pantograph, minimising overhead line damage. British Rail Research have also developed a system called OLIVE™ (Overhead Line Inspection by Vehicle Equipment) which uses fibre optic sensors to monitor along-track accelerations (impacts) of the pantograph and to record such signals that exceed a pre-set threshold together with time and location signals so giving an indication of damage to the overhead line.

The inventors have realised that it is possible to use signals indicating current collector condition and/or damage with signals indicating vehicle location to locate regions of potentially damaged overhead conductor without the complexity of additional equipment to monitor pantograph accelerations and without optical inspection of the OCL (although both can be done additionally if desired).

They have also noted that Fibre Bragg Grating (FBG) sensors provide a robust means of measuring current collector condition when placed in the collector itself. Fibre Bragg Gratings comprise an optical fibre with a grating arranged to provide a reflected component to light passing through the fibre and of appropriate wavelength to interfere with the spacing of the grating. Since the spacing will vary according to strain and/or temperature, the wavelength reflected will vary with these parameters.

U.S. Pat. No. 6,587,188 proposes the use of fibre Bragg Gratings as strain and temperature sensors in vehicle applications.

Fibre Bragg Gratings can be designed to measure temperature or strain, and force can be derived from strain measurements. An example of a Fibre Bragg Grating that is temperature independent but which shows a good response to strain, is described in “Temperature-Independent Strain Sensor System Using a Tilted Fiber Bragg Grating Demodulator”, IEEE Photonics Technology Letters, Vol. 10, No. 10, October 1998, Page 1461. Conversely, strain isolated Fibre Bragg Gratings can be used for temperature measurement.

Fibre Bragg Gratings sensors have the ability to measure directly at critical stress points and at high voltage while not being adversely affected by high temperatures and high electromagnetic fields. They are also capable of transmitting the optical signals over significant distances of fibre cable without degradation.

According to the invention there is provided a current collector comprising one or more Fibre Bragg Grating sensors mounted on or in the current collector.

The present invention is not limited to any particular type of Fibre Bragg Grating, so long as it is capable of providing the desired indication of collector condition. However, an advantageous geometry for measuring strain comprises a strain grating and compensating temperature grating (see for example http://www.vtt.fi/tuo/74/projects/conmo.htm for a description of such a unit) preferably these are combined in a single unit

The present invention also provides a dynamic or static monitoring system for electric vehicles drawing current from overhead conductors through current collectors on pantographs, the system comprising
i) detector means in the collector to generate a current collector condition and/or damage signal at a predetermined level likely to cause damage to the overhead conductor, and
ii) locating means operatively connected to said detector means to generate a signal indicating the location of the pantograph on the overhead conductor at which the current collector damage signal was generated.

The detector means preferably comprise one or more Fibre Bragg Grating sensors mounted on or in the current collector.

The current collector damage signal may be a signal initiating, or initiated by, the dropping of the pantograph head.

The current collector damage signal may be generated by wear/damage detection apparatus comprising at least one optical fibre embedded in the current collector, an optical transmitter and an optical detector to detect light in the optical fibre. The apparatus will allow for detection of wear if the wear/damage detection apparatus comprises more than one optical fibre embedded into the current collector at different distances from the wear surface.

A microprocessor may be used to analyse the output from the optical detector and generate a signal describing the level of wear of the current collector and/or, as appropriate, a signal to drop the pantograph from the overhead wire.

A global positioning system (“OGPS”) may be used as the locating means. GPS is a satellite-based radio-navigation system that provides continuous global coverage to an unlimited number of users. GPS provides the position of the pantograph in terms of degrees of latitude and longitude.

The invention may also provide a pantograph monitoring system which establishes the condition and location of a pantograph current collector in use on an overhead wire, the system comprising:
i. a current collector having a wear/damage detection apparatus which emits a signal;
ii. a micro-controller which analyses the emitted signal, assesses the wear/damage of the current collector, and which can, as appropriate, produce an output to describe the level of wear or automatically to withdraw the pantograph from the overhead wire;
iii. a positioning system which is linked to the micro-controller and which locates the pantograph at the time of said wear/damage; and
iv. a display unit which displays the level of wear/damage and location of the pantograph.

Such a monitoring system provides a useful adjunct or even partial replacement for systems in which pantograph accelerations are measured.

Further features of the invention comprise the use of strain gauges (preferably fibre Bragg Grating sensors) to measure the forces acting on the current collector, and the provision of control of the pantograph, signals from the strain gauges being processed to provide control signals for the pantograph.

The invention allows for monitoring the operational conditions of the pantograph in real time. Wear levels of the carbon current collector can be closely monitored by the system. This enables the current collector to be replaced at a convenient time. If the current collector is damaged when in use, the system can generate a signal which will automatically drop the pantograph head away from the overhead line. This greatly reduces the potential for any damage. If a location unit is provided (e.g. a GPS unit) this accurately locates the position of the current collector where the crack damage occurred. This provides an accurate location for the area on the line to be checked by a maintenance engineer. The Fibre Bragg Grating sensors can provide either or both temperature and strain measurement. When used in connection with means to monitor pantograph accelerations a body of data may be collected that is indicative of the condition of the overhead conductor.

The invention is described with reference to the accompanying drawings, in which:

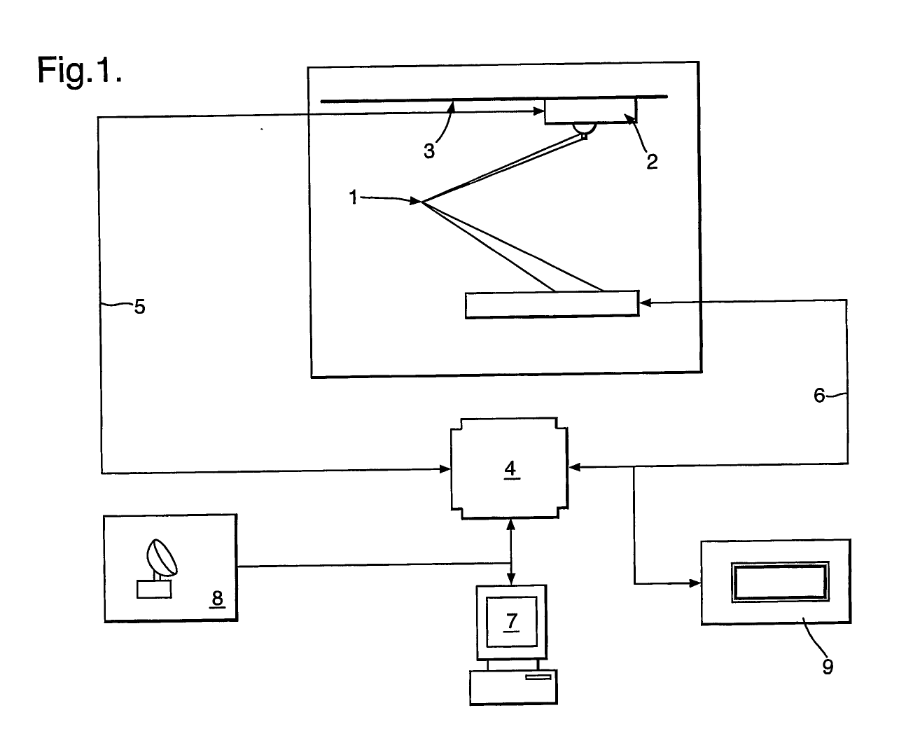

FIG. 1 is a diagram showing the inter-relationship of the various components in the preferred system;

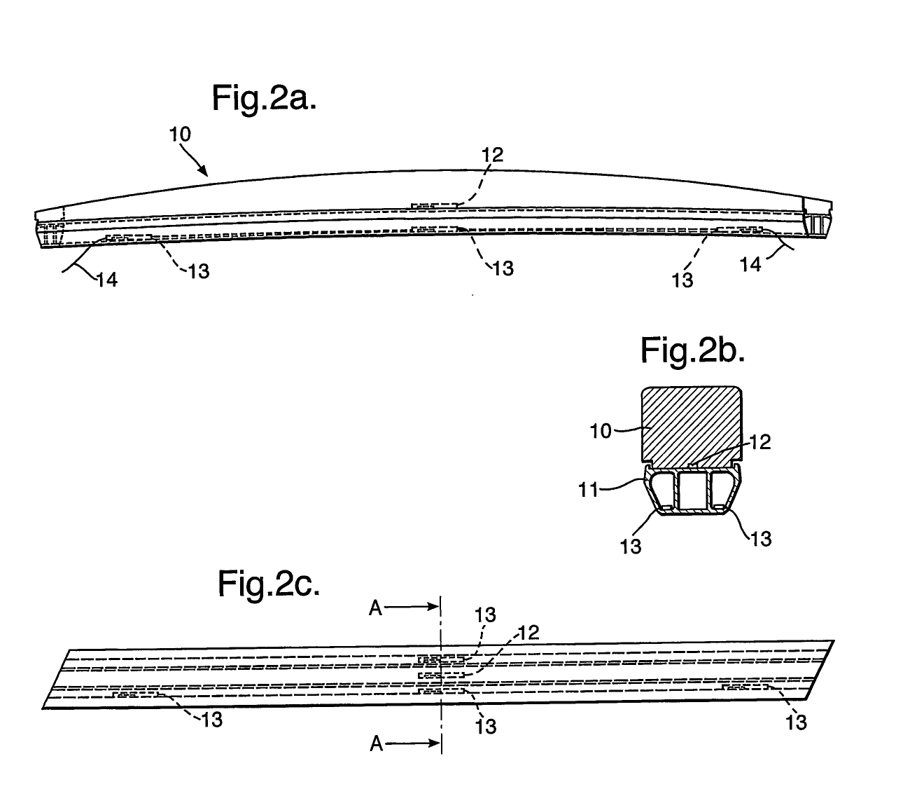

FIG. 2 shows a collector fitted with Fibre Bragg Grating sensors suitable for use in the present invention;

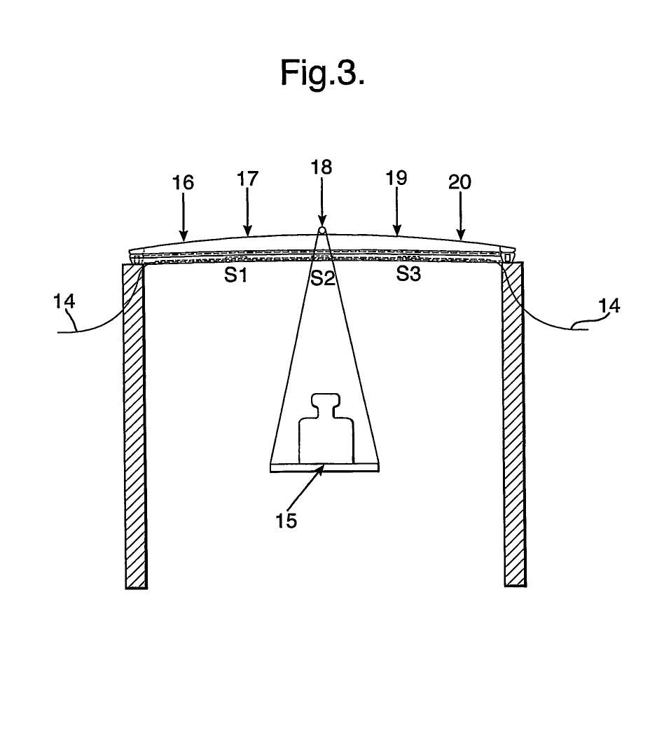

FIG. 3 shows a test method for the collector of FIG. 2;

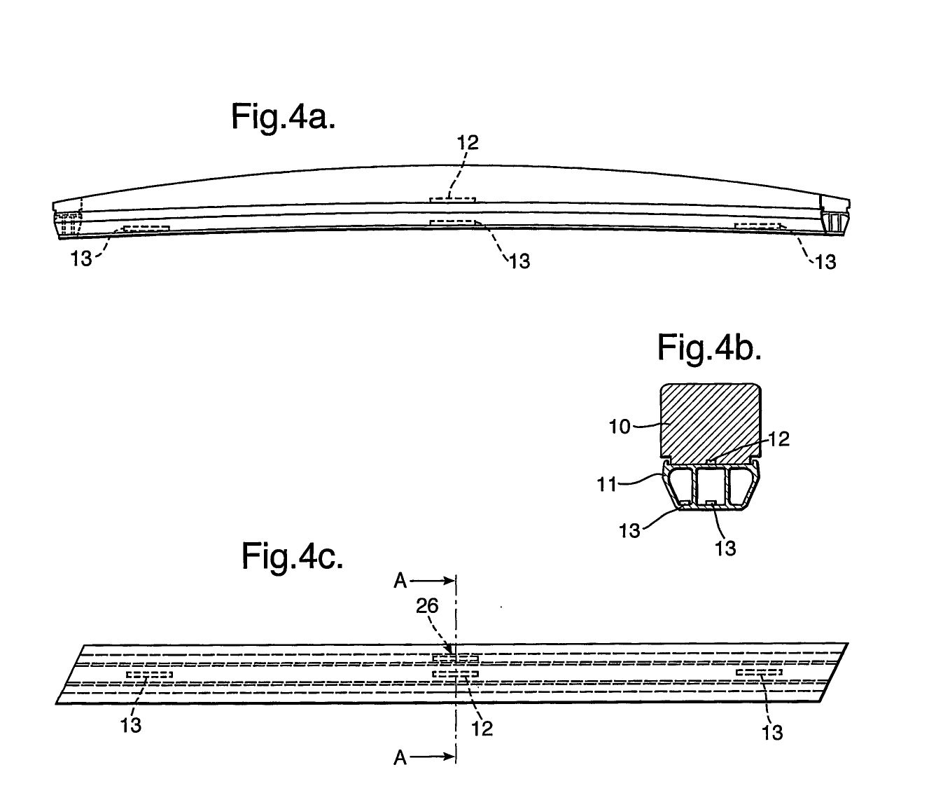

FIG. 4 shows an alternative collector fitted with Fibre Bragg Grating sensors suitable for use in the present invention;

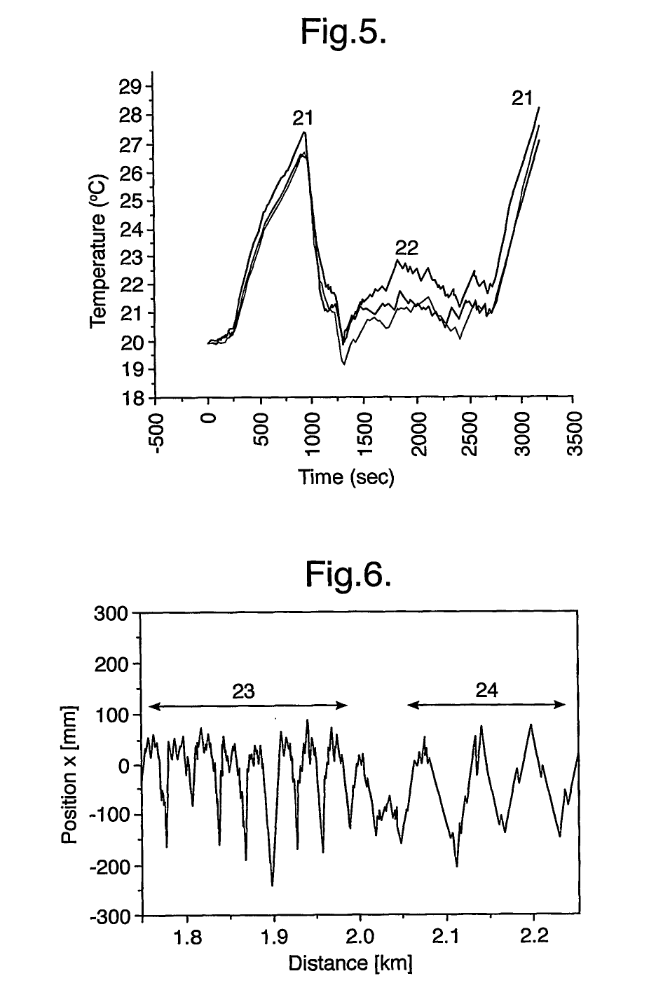

FIG. 5 shows experimentally determined temperatures of a current collector as it moves from a station and travels to a second station;

FIG. 6 shows experimentally determined positions of an overhead conductor on a current collector for a vehicle moving from a curved to a straight section of track;

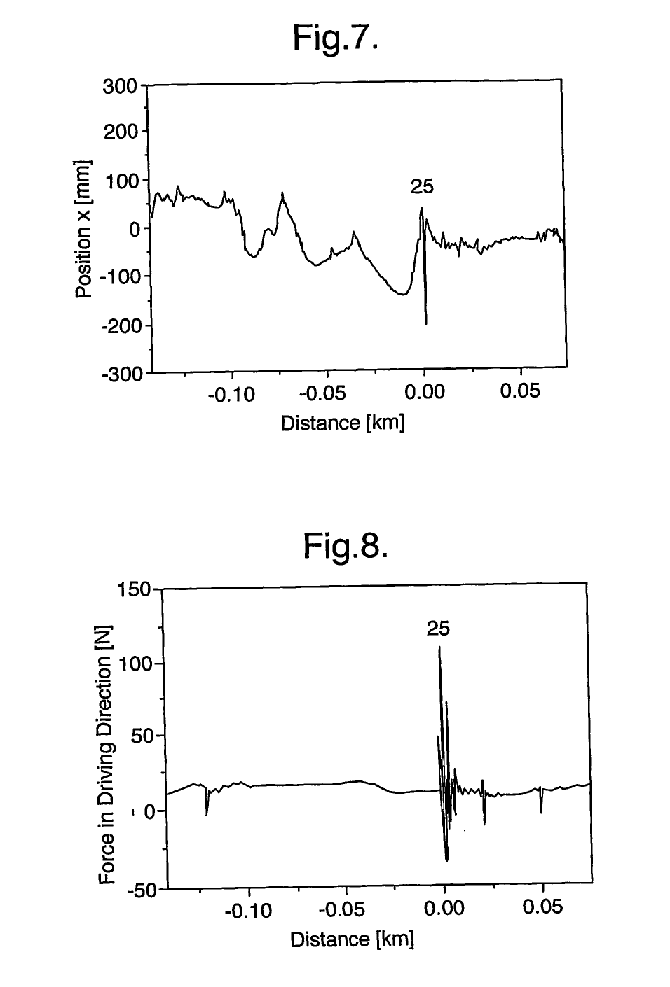

FIG. 7 shows experimentally determined positions of an overhead conductor on a current collector for a vehicle before and after passing a track switch isolator; and

FIG. 8 shows experimentally determined force in the driving direction determined at the same time as FIG. 7.

The system shown in FIG. 1 comprises a pantograph 1 carrying a current collector 2 against a conductor 3 (such as an overhead wire). Current collector 2 incorporates one or more optical fibres.

The system shown in FIG. 1 further comprises a micro-controller-based real time condition monitoring sub-system and a sub-system for the storage and presentation of information. The real time condition monitoring sub-system is based on micro-controller 4. The micro-controller generates and receives a checking signal 5, which is transmitted through the optical fibres of the current collector 2 to sense any wear/damage to the current collector. The operational condition of the current collector 2 can be deduced according to the difference between the generated and received signals. If any wear/damage has occurred then a warning signal or a pan-head drop signal 6, as appropriate, will be produced by micro-controller 4 to remove the pantograph 1 with associated current collector 2 away from the overhead wire 3.

Other signals may be processed by micro-controller 4 such as signals from strain gauges indicative of the forces acting on the current collector and these other signals, if they indicate operation outside predetermined parameters, may be used to generate a warning signal or a pan-head drop signal 6, as appropriate. Since the forces on a pantograph are dependent on both the acceleration of the vehicle carrying it and the state of the overhead conductor against which it bears, forces outside pre-set parameters can indicate damage done to the overhead conductor. The predetermined parameters should take into account the normal operating variations in forces to be expected such as those forces due to changes in the height of the overhead conductor (such as on entering a tunnel), and other anomalies part of the design of the overhead system.

A suitable type of sensor for use in such applications is an optical strain gauge based on the principle that polarised light passing through as optical medium may have its polarity changed by pressure, or other forces, applied to the medium. Such sensors are described in EP-A-0014373 and EP-A-0289120. However such sensors show an undesirable temperature sensitivity, and so even better are Fibre Bragg Grating sensors as described further below with reference to FIGS. 2 and 3.

The second sub-system for the storage and presentation of the information, is advantageously based upon a personal computer (“PC”) 7 which processes and stores relevant information. The operational conditions of the pantograph 1 and its associated current collector 2 are transferred to the PC 7 from the micro-controller 4. The location of the pantograph 1 along the overhead wire 3 is obtained from a GPS unit 8 which is directly linked to the PC 7. The PC 7 can link together the condition of the current collector 2 and its position, displaying this information on the screen and saving it in files. The system may monitor continuously the condition of the pantograph 1 and current collector 2, its location on the conductor 3 being found when desired.

All operational conditions of the pantograph may be displayed, e.g. on a LCD unit 9, including wear level and crack damage.

Thus, three important pieces of information are generated by the system: these are a) the working condition of the current collector; b) the condition of the overhead conductor; and c) the location and speed of the train. These pieces of information need to be recorded at the same time. This is done by the micro-controller.

The system can also provide details of the train's speed over the ground and time and date. This data can be transmitted to the PC, processed, linked to the working conditions of the pantograph, saved to a file and displayed on the screen.

A further advantage to the present invention is that by monitoring the forces acting on the current collector it is possible to provide a closed loop control system for the pantograph. Conventionally a steady upward force is applied to the pantograph to keep the current collector in contact with the conductor. By using a closed loop control system as the forces on the current collector increase the upward force on the pantograph may be decreased (or vice versa) so as to maintain the forces experienced by the current collector within a chosen range. This offers the prospect of reduced collector and conductor wear.

The invention describes a system with a very fast response compared to the speed of the unit controlling the pantograph arm. The time period from the start of detection of a crack to the generation of pan-head drop signal can be very short (a few ms). This is sufficiently fast to respond to any crack damage caused by large impacts. At present systems comprising an inflated distensible tube in a cavity in the current collector take a comparatively long time to generate a pan-head drop signal. This is because the time taken to generate the signal is dependent on the size of the rupture to the distensible tube. It takes an appreciable time for the pressure in the tube to drop sufficiently for the drop to be sensed and acted on. In contrast the fast response time of the present invention allows rapid dropping of the pantograph and accurate fixing of the position at which the drop occurred.

FIG. 2 shows a typical collector in accordance with the invention. A collector 2 is shown in side elevation (FIG. 2a) section on line A-A (FIG. 2b) and plan (FIG. 2c). The collector 2 comprises a carbon collector body 10 and a metal carrier 11. A Fibre Bragg Grating temperature sensor 12 is embedded within the carbon collector body 10. Strain and temperature sensors 13 are fixed to the metal carrier 11. Fibre optical cables 14 are connected to the sensors and pass to the micro-controller 4.

The number of sensors required and their positions will vary depending on the size of collector and the accuracy required from the measurement The sensors will either be embedded and adhered into a channel machined in the carbon, as with the temperature sensor 12 above, or adhered into channels in the metal carrier 11. The sensors 13 may be used to detect both strain and temperature.

With the sensors fitted in position as shown the following measurements will be possible:

Temperature of the collector.

Contact force with the overhead wire

Detection of vertical force, particularly excessive vertical force

Position of overhead on collector

Force in the direction of travel

Detection of impact force, particularly excessive impact force

This information will be used to inform the operator of possible damage or risk to the collector, pantograph or overhead contact line. The operator can then take action to prevent further damage occurring. The information may also be used to provide an automatic response to collector condition.

### EXAMPLE

Using simulation software programmed with the material properties of carbon and aluminium, a model was generated to predict the effects of applied forces and temperature variations on the collector strip. From this model it was found that the areas of maximum strain were on the top of the carbon collector body and base of the carrier, and the minimum strain was at the carbon/carrier interface.

As a result of the model, it was determined that the ideal position for the strain sensors is in the base of the carrier remote the carbon collector body (area of maximum strain) since they cannot easily be placed at the top of the carbon at the contact surface. The best position for the temperature sensor is at the interface where it is least affected by variations in strain. The sensor can be placed within the carbon collector body, within the metal carrier, or bridging the interface.

Following the strain modelling, a simulation was programmed for predicting temperature changes due to variations in current and contact resistance. This model was checked against experimental data from an actual collector strip and the maximum temperature rise determined.

The next stage was to develop a collector with three sensor pads fitted for measuring strain, thus allowing the position and magnitude of an applied force to be determined. Each of the sensor pads consisted of a strain FBG and a compensating temperature FBG. The sensor pad was adhered to the base of the aluminium with the strain sensor in contact with the surface.

The collector was set-up as shown in FIG. 3 with the ends supported and the force applied with varying weights 15 at varying positions 16,17,18,19,20 along the collector via a section of overhead wire. The sensors used Fibre Bragg Gratings of different wave lengths as follows:

S1=838 nm, S2=845 nm, S3=849 nm

[The present invention is not limited to any particular wavelengths, and in particular industry standard sensors using wavelengths around 1550 nm may be used].

This allowed the magnitude of the force applied to a specific position to be calculated from the strain produced on each sensor. Good agreement between calculation and applied force was obtained.

Following the success of the above experiment, sensors were fitted to an aluminium carrier prior to joining with the carbon. The reason was to ensure that the sensors were able to function correctly after being subjected to the carbon bonding process.

The carbon was then assembled with the embedded temperature sensor and bonded to the aluminium with adhesive and heat cured The sensor output was found not to have been adversely affected by the process.

The sensors measure temperature and strain. A multiplexed sensor network embedded into the carbon strip and the carrier supplies spatial resolved information as the OCL moves in zigzag form across the collector. This results in a means of permanently monitoring the thermal and mechanical stress load caused by a train running under the overhead contact line (OCL).

Subsequent interrogation of these sensors will allow adjustment of the pantograph to enable optimum rung conditions for the overhead collector, thus reducing wear of both the collector head and OCL.

FIG. 4 shows an alternative form of collector used in a series of trials of the invention. In this collector the strain and temperature sensors 13 are aligned along the centre line of the collector rather than to one side. Sensor 26 is positioned to one side and at the front of the collector to serve as an impact sensor.

Such sensors were used in a trial of the invention on a locomotive. FIG. 5 shows the measured collector temperature, on a sunny day, as a locomotive moved between stations. Peaks 21 show high temperatures while the locomotive is at rest, while the lower temperatures in region 22 show the effect of air cooling as the locomotive is in motion.

FIG. 6 shows experimentally determined positions of an overhead conductor on a current collector (expressed in terms of mm deviation from an ideal position on the collector) for a vehicle moving from a curved to a straight section of track. In normal use, as a vehicle travels, an overhead conductor will move across the collecting face of the collector. Such movement is a natural part of the function of the collector as it has to deal with movement of the vehicle. The graph shows a clear difference is between region 23, which shows the rapid side-to-side movement common to a curve, and region 24, which shows the slower side-to-side movement on the straight track. The ability to determine the position of the conductor with respect to the collecting face of the collector is a useful feature of the present invention.

FIG. 7 shows similarly determined position on a current collector for a vehicle before and after passing a track switch isolator, and FIG. 7 shows the corresponding force in the driving direction. The isolator can clearly be seen at point 25 in both graphs and the usefulness of the present invention in clearly identifying impacts can be seen.

The concept of embedding fibre optic sensors to indicate distributed temperature and strain in carbon is novel. The sensors can be addressed by any suitable means. Preferably the sensors are placed along a single fibre line, which can be addressed and interrogated by a single evaluation unit.

Data gathered from these sensors reflect the conditions experienced by the collector and provide information for the effective operation of the current collector and the condition of the OCL.

Temperature signals from temperature sensors can be used to give signals indicative of thermal overload conditions, and such signals can be used to control the current flowing through the collector (e.g. by switching off circuits, controlling subsidiary apparatus to reduce demand, or even by dropping the pantograph if necessary).

The excellent isolation properties and immunity to electrical interference of Fibre Bragg Grating sensors make the optical method of transferring measurements particularly advantageous. Low cost signal processing and world-wide satellite coverage allows positional data to be combined with OCL condition monitoring leading to predictive line maintenance and correction before a catastrophic failure can occur.

In addition to overhead collector strips, the Fibre Bragg Grating sensors may be utilised in collector shoes for traction and industrial applications. They can also be modified for use in carbon brushes for electrical machinery.

Such a system permits measurement of the applied contact force and force in the driving direction dynamically when the locomotive is running. In addition, it will detect excessive vertical force or excessive impact forces in the driving direction. Such measurement will be a useful source of information for maintaining not only the currenct collectors on a locomotive, but also the conductor.

1-22. (canceled)

23. A current collector comprising one or more Fibre Bragg Grating sensors mounted on or in the current collector.

24. A current collector as claimed in claim 23, in which at least one of said Fibre Bragg Grating sensors comprises a strain grating and a compensating temperature grating.

25. A current collector as claimed in claim 23, comprising a carbon collector body and a metal carrier.

26. A current collector as claimed in claim 25, in which Fibre Bragg Grating strain gauges are situated on or within the metal carrier.

27. A current collector as claimed in claim 25, in which the Fibre Bragg Grating strain gauges are situated on or within the carbon collector body.

28. A current collector as claimed in claim 25, in which Fibre Bragg Grating temperature gauges are situated at the interface of the carbon collector body and the metal carrier.

29. A monitoring system for electric vehicles drawing current from conductors, the system comprising:
i) detector means in the collector to indicate a current collector condition and/or damage signal at a predetermined level likely to cause damage to the conductor; and
ii) locating means operatively connected to said detector means to generate a signal indicating the location of the current collector on the conductor at which the current collector damage signal was generated.

30. A monitoring system, as claimed in claim 29, in which the conductor is an overhead conductor, and the current collector is mounted on a pantograph having a pantograph head.

31. A monitoring system as claimed in claim 30, in which the current collector damage signal is a signal initiating, or initiated by, the dropping of the pantograph head.

32. A monitoring system as claimed in claim 29, in which the current collector condition and/or damage signal is generated by a wear/damage detection apparatus comprising at least one optical fibre embedded in the current collector, an optical transmitter and an optical detector.

33. A monitoring system as claimed in claim 29 and comprising a microprocessor to analyze the output from the optical detector and capable of generating a signal describing the level of wear of the current collector.

34. A monitoring system as claimed in claim 31 and comprising a microprocessor to analyze the output from the optical detector and capable of generating a signal to drop the pantograph from the overhead wire.

35. A monitoring system as claimed in claim 29, wherein the locating means is a global positioning system.

36. A monitoring system as claimed in claim 29 and comprising:
i) a current collector having wear/damage detection apparatus which emits a signal;
ii) a micro-controller which analyzes the emitted signal, assesses the wear/damage of the current collector, and which can, as appropriate, produce an output to describe the level of wear or automatically to withdraw the current collector from the conductor;
iii) a positioning system which is linked to the micro-controller and which locates the current collector at the time of said wear/damage; and
iv) a display unit which displays the level of wear/damage and location on the conductor of the current collector.

37. A monitoring system, as claimed in claim 29, further comprising a temperature sensor incorporated in the collector to generate a signal indicative of thermal overload conditions.

38. A monitoring system for electric vehicles drawing current from overhead conductors through current collectors on pantographs, the system comprising
i) detector means in the collector for generating a signal indicative of force acting on the current collector; and
ii) locating means operatively connected to said detector means for generating a signal indicating locations of the pantograph on the overhead conductor at which the signal indicative of force acting on the current collector exceeds a level likely to cause damage to the overhead conductor.

39. A monitoring and control system for electric vehicles, as claimed in claim 38, in which the detector means is a Fibre Bragg Grating strain gauge.

40. A monitoring system, as claimed in claim 38, further comprising a temperature sensor incorporated in the collector to generate a signal indicative of thermal overload conditions.

41. A monitoring and control system for electric vehicles drawing current from overhead conductors through current collectors on pantographs, the system comprising detector means in the collector to indicate the forces acting on the current collector, and control means to process signals from the detector means and to generate control signals for the pantograph.

42. A monitoring and control system for electric vehicles, as claimed in claim 41, in which the pantograph is controlled to maintain the forces experienced by the current collector within a chosen range.

43. A monitoring and control system for electric vehicles, as claimed in claim 41, in which the detector means is a Fibre Bragg Grating strain gauge.

44. A monitoring system, as claimed in claim 43, wherein the Fibre Bragg Grating strain gauge measures force to determine the position of the conductor with respect to a collecting face of the collector.

45. A monitoring system, as claimed in claim 41, further comprising a temperature sensor incorporated in the collector to generate a signal indicative of thermal overload conditions.

46. A monitoring system, as claimed in claim 44, in which the signal indicative of thermal overload conditions is used to control the current flowing through the collector.

47. A monitoring system, as claimed in claim 41, used as an adjunct to a system in which current collector head accelerations are measured.
